(19) United States
(12) Patent Application Publication
(10) Pub. No.: US 2009/0192941 A1
(43) Pub. Date: Jul. 30, 2009

(54) DIGITAL MARKETPLACE FOR HEALTHCARE DATA

(76) Inventors: Lisa Fournier, Lexington, KY (US); Thomas W. Leiper, Stamford, CT (US)

Correspondence Address: ST. ONGE STEWARD JOHNSTON & REENS, LLC, 986 BEDFORD STREET, STAMFORD, CT, 06905-5619, US

(21) Appl. No.: 12/325,782

(22) Filed: Dec. 1, 2008

Related U.S. Application Data
(60) Provisional application No. 60/991,022, filed on Nov. 29, 2007.

(51) Int. Cl. G06Q 30/00; G06Q 50/00; G06Q 40/00; G06Q 20/00; G06F 21/00; G06F 17/30

(52) U.S. Cl. 705/51; 705/1; 705/3; 705/39; 705/80; 707/104.1; 707/3; 707/E17.108; 707/E17.044

(57) ABSTRACT

A system for facilitating commercial exchange of packages of electronic health records, including practice nodes in communication with one another via a peer to peer network, each practice node having a plurality of electronic medical records including medical data and patient identification data, a digital marketplace server including software for receiving a query for medical data from a user and identifying practice nodes having the medical data responsive to the query, software executing on the practice nodes for generating summaries of the medical data responsive to the query, blinding the summaries and transferring the blinded summaries to the digital marketplace server, software executing on the server for displaying the blinded summaries and receiving an order for the medical data described in the blinded summaries, and software executing on the practice nodes for blinding electronic medical records containing the ordered medical data and transferring the blinded medical data to the user.

### CROSS-REFERENCE TO RELATED APPLICATIONS

The present application claims the benefit under 35 U.S.C. §119(e) of the U.S. Provisional Patent Application Ser. No. 60/991,022, filed on Nov. 29, 2007, the content of which is incorporated herein by reference.

### FIELD OF THE INVENTION

The invention relates to the electronic record keeping and distribution systems, and more specifically to a system and method for transacting medical and practice information.

### BACKGROUND OF THE INVENTION

Patient's medical records contain a wealth of information useful for the research community. For example, each medical record generally contains detailed information such as symptoms of particular illnesses and the effectiveness of treatments which may not otherwise be accessible to physicians or researchers. Having access to such information could be invaluable in the search for new treatments and cures for many illnesses. Further, access to such data would provide physicians with an abundance real life data for use in evaluating treatment options for their patients.

A significant problem in the accessibility of medical records is the security issues associated with sharing medical records. Most patients would likely be hesitant to make their records accessible, for treatment or otherwise, without being sure that the data is secure from unauthorized access and identification. Other factors complicating the sharing or release of a patient's medical records include the regulatory requirements imposed by the Health Insurance Portability and Accountability Act of 1996 (“HIPAA”). This regulatory framework, established by Congress, obligates physicians to maintain the confidentiality of patient records that identify particular individuals and any medical conditions they may suffer from.

Commonly owned U.S. Pat. No. 7,438,233 and U.S. patent application Ser. No. 12/255,443, incorporated herein by reference, describe systems and methods for transferring and updating sensitive data such as medical records. These systems and methods provide a solution for the security issues associated with sharing medical records by “blinding” the medical records to allow for the transfer and clinical use of anonymous medical information.

It is desired to provide a system and method for the distribution, sale, and promotion of the blinded medical data. It is further desired to provide a digital marketplace for healthcare data including the blinded medical data and other medical and practice information.

### SUMMARY OF THE INVENTION

It is an object of the present invention to provide a system and method to transact medical and practice information. The present invention aims to offer a new type of business model for the healthcare industry: one that creates efficiencies via an electronic health record system and provides medical best practices, and generates a revenue stream to offset operating costs and provide an annuity to the healthcare professional by leveraging already available data—the patient chart.

It is a further object of the present invention to provide advantageous features and functions using blind data and information through a patient record and the digital marketplace system including: research queries regarding various medical conditions and outcomes of treatment, exploring new treatment methods and drugs through controlled access to stored data in the patient electronic medical record keeping system.

It is also an object to provide for comparative analysis of individual cases against a sample of blinded cases, the main objective being to help physicians identify best practices that work among those that simply are “practiced,” and for doctors to negotiate reduced rates for their malpractice insurance if they agree to perform such comparative analysis on all patients and document their reasoning for alternative practice(s).

These and other objects are achieved by providing a system for facilitating commercial exchange of packages of electronic health records including two or more nodes in communication with one another via a peer to peer network. At least a portion of the nodes include a plurality of electronic medical records. The system further includes a digital marketplace server in communications with the peer to peer network including software for receiving a query from a user, software executing on the server for identifying at least one of the nodes having medical data responsive to the query, software executing on the server for displaying to the user summaries of the medical data responsive to the query, and software executing on the server for receiving an order for at least a portion of the medical data described in the summaries. The system also includes software executing on the nodes for transmitting the ordered medical data from the nodes having the medical data to the user.

In some embodiments, the software for receiving the order receives payment from the user, the payment based on price terms predefined by the nodes having the ordered medical data. The software for receiving the order may also receive a price bid from the user and an acceptance or counterbid from the nodes having the ordered medical data. The software for receiving the order may also transmit to the user a verification code and a link to the particular nodes having the ordered medical data.

The system may further include software executing on the nodes for generating the summaries of the medical data responsive to the query, blinding the summaries and transferring the summaries omitting patient identification data to the digital marketplace server. In some embodiments, the software for transmitting the medical data from the nodes also blinds electronic medical records containing the ordered medical data and transfers the blinded medical data omitting patient identification data to the user.

Other objects are achieved by provision of a system for facilitating commercial exchange of packages of electronic health records, including a plurality of practice nodes in communication with one another via a peer to peer network, each practice node having a plurality of electronic medical records including medical data and patient identification data. The system includes a digital marketplace server in communication with one another via a peer to peer network including software for receiving a query for medical data from a user, and software executing on the server for identifying at least one of the practice nodes having the medical data responsive to the query. The system also includes software executing on the practice nodes for generating summaries of the medical data responsive to the query, blinding the summaries and transferring the blinded summaries omitting patient identification data to the digital marketplace server. Further included is software executing on the server for displaying the blinded summaries to the user, software executing on the server for receiving an order for at least a portion of the medical data described in the blinded summaries, and software executing on the practice nodes for blinding electronic medical records containing the ordered medical data and transferring the blinded medical data omitting patient identification data to the user.

Other objects of the present invention are achieved by a method for commercial exchange of packages of electronic health records, including the steps of receiving a query for medical data from a user, identifying at least one of a plurality of nodes having the medical data by broadcasting the query via a peer to peer network to the plurality of nodes and receiving, from at least one of the nodes, the summaries of the medical data available at the node, transmitting the summaries of the medical data available from the nodes to the user, receiving an order for at least a portion of the medical data described by the summaries from the user, receiving payment from the user, and transmitting the ordered medical data from the particular nodes having the ordered medical data to the user.

In some embodiments, the nodes blind the summaries to omit patient identification data before the summaries are transmitted to the user. The method may also include the step of blinding the ordered medical data to remove patient identification data.

In some embodiments, the step of receiving payment includes receiving a price bid from the user and an acceptance or counterbid from the nodes having the ordered medical data, and transmitting at least a portion of the payment to the nodes having the ordered medical data.

Other objects of the invention and its particular features and advantages will become more apparent from consideration of the following drawings and accompanying detailed description.

### BRIEF DESCRIPTION OF THE DRAWINGS

FIG. 1 illustrates a system according to an exemplary embodiment of the present invention.

FIG. 2 illustrates a research network of the system shown in FIG. 1.

FIG. 3 illustrates a digital marketplace, buyer's workstation, and practice of the system shown in FIG. 1.

FIG. 4 illustrates consolidator and practice levels of the system shown in FIG. 1.

FIG. 5 is a flow diagram illustrated a query in the system shown in FIG. 1.

FIGS. 6A-6E illustrate exemplary user interfaces of the system shown in FIG. 1.

### DETAILED DESCRIPTION OF THE INVENTION

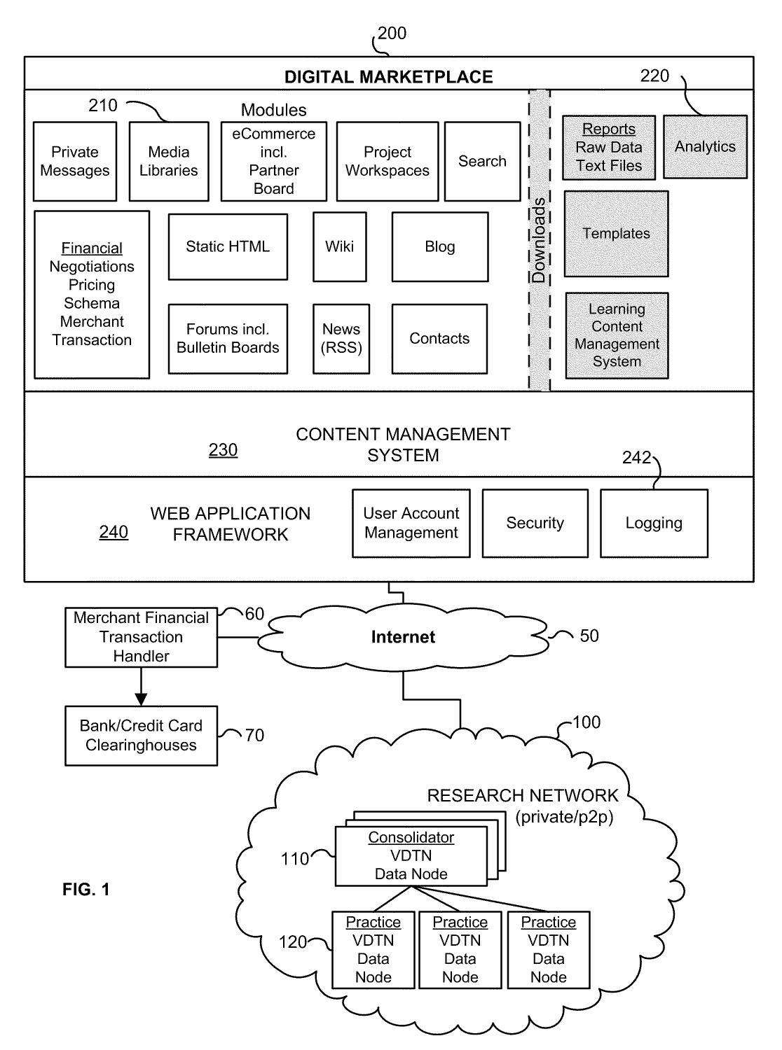

FIG. 1 illustrates a system according to an exemplary embodiment of the present invention. The system includes hardware and/or software for transacting medical and practice information. As described in more detail below, the information may include patient data (e.g., blinded patient data) and other information prepared and offered by users of the system such as physicians. Patient or medical data transacted by the system includes information regarding various medical conditions and outcomes of treatments from individual patient medical records.

The present invention includes one or more components described in commonly owned U.S. Pat. No. 7,438,233 and U.S. patent application Ser. No. 12/255,443, which are incorporated herein by reference, and are therefore not discussed in detail. For example, the present invention may include or be in communication with a transaction processor, and one or more databases or storage means including any number of data records. The databases may include a directory including information concerning users of the system and consolidators accessible by the transaction processor. The system may also include or be in communication with one or more consolidators or data aggregators.

As shown in FIG. 1, the system according to the present invention includes a research network 100. The research network 100 is a peer-to-peer (“P2P”) network including any number of “peers” or data nodes, including consolidator data nodes 110 and practice data notes 120. In a preferred embodiment, each peer data node includes peer software. For example, a practice data node 120 may include peer software loaded on the practice's server and accessible by practice users at a plurality of workstations. The peer software includes software for accessing a virtual data transformation node (“VDTN”) of the system (e.g., VDTN client software). The practice data nodes 120 hold the patient or medical data of the network 100 and respond to requests for transfer of that data. The practice data nodes 120 also encrypt and decrypt the medical data.

Consolidators 110 have access, authority, and/or control over any number of sensitive data records. In some embodiments, patient data and/or medical records are accessible by the consolidator 110 but stored at the practice data nodes 120, e.g., by the patient's doctor inside the practice walls. The consolidators 110 act much like the “hub” in a “spoke and hub” model, always understanding where desired information is stored (patient, entity, services, etc.) and brokering/facilitating the inquiring user with that desired information. In some other embodiments, a practice 120 or entity that houses the consolidator 110 stores the medical data on behalf of one or more other practices 120. The consolidator 110 may then receive some or all of the initial data queries on the practice's behalf. Some other practices 120 operate without a consolidator 110 and communicate directly with buyers and sellers via the network 100.

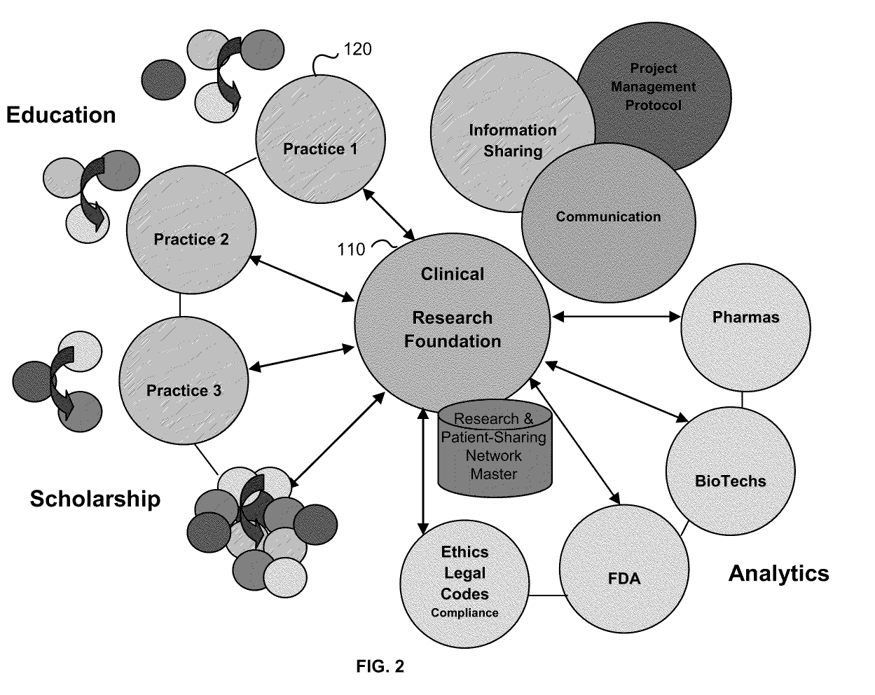

In some embodiments, small communities of users are linked in a larger network of users through consolidators 110. See, e.g., FIG. 2. The communities may, for example, be based on a common interest, a specific area of medical practice (e.g., radiology), or a location. A community gateway (non-blinded, shared patient information among providers) and the digital marketplace 200 (blinded data for research, analytics, and brokering of outside services) ties the communities or “Sub-Communities” together (via communications and protocols) resulting in building a dynamic system (e.g., “SMS Research and Patient-Sharing Network”). A named collection of peer nodes that can communicate among themselves may be referred to a “mesh,” and assigned a unique mesh ID.

Some communities or networks of the present invention provide for virtual preferred provider organizations (“PPO”) wherein physicians form PPO groups based upon a particular specialty instead of providing comprehensive coverage. For instance, a middle-aged heart patient executive who travels a lot on business may prefer to purchase coverage from a virtual group of cardiologists who he knows utilize best practices derived from their common network experience.

The system further includes the digital marketplace 200. The digital marketplace 200 comprises software and/or software modules executing on a server (e.g., transaction server or processor). The digital marketplace 200 is a facilitator, rather than a data provider, for facilitating the exchange of information between data providers and data consumers. The digital marketplace 200 allows content sellers (i.e., physicians, 3rd-party content providers, etc.) to upload, manage, package and sell their wares via an ecommerce component of the system. Users of the system can enter data by using clinical and business components/modules as a practice EHR/EMR on a daily basis and for each patient, or by entering data by hand into the form fields in a clinical component of the digital marketplace 200.

The digital marketplace 200 maintains a list of consolidators 110 in the network 100 and a list of users and/or administrative users associated with practices 120 managed by each consolidator 110. This information is preferably stored in a table (e.g., by the transaction server).

As shown in FIG. 1, the research network 100 is in communication with the digital marketplace 200 via the Internet 50. The digital marketplace 200 includes or is in communication with several modules 210. The system may include modules 210 for physicians to store patient data on-site at their practice (e.g., clinical and/or business modules) and to securely transmit patient information and/or medical data to other users of the system. Physicians and other users may then leverage the peer-to-peer network 100 that authenticates subscribers, analyzes and shares data (e.g., analytics module), and creates a knowledge-base (e.g., Media Libraries) for research and learning (e.g., e-learning module) within and outside the medical community (Portals: Physician Center, Patient Portal) leveraging a variety of strategic partners.

In some embodiments, the digital marketplace 200 also includes enterprise and ecommerce modules to provide a social networking aspect to forge and facilitate relationships, provide buying power in and amongst the user communities, and a sales accelerator model to provide the seller the most value for the asset purchase (data). The digital marketplace 200 also includes peer review and community features, such as Wikis, blogs, forums, news—RSS, peer review, project collaboration tools, and private messaging.

The digital marketplace 200 may also provide for continuing education wherein physicians learn new techniques, formulate and conduct targeted research studies or queries from blinded data, purchase studies and material via the micro-publishing tool, all in the course of treating their patients (e.g., Learning Content Management System module). In some embodiments, physicians obtain continuing education credit by virtue of appropriate accreditation of the digital marketplace 200.

The digital marketplace 200 collaborates with the research network 100 to access and receive blinded medical records and other data and information from practice's and EHR/EMR databases. For example, users of the digital marketplace 200 are able to perform research network searches and obtain the blinded medical data from the practice data nodes 120. Users may include digital marketplace 200 subscribers who are registered users in the digital marketplace 200, such as physicians, specialists, universities, government agencies, pharmaceutical companies, associations, and research groups. Users can create content, consume content, sell content, buy content, collaborate on content, and/or participate in the community discussions. Users can purchase content created by commercial researchers, such as drug and device manufacturers, to further R&D, streamline operations or conduct virtual clinical trials and other assessments for the purpose of regulatory approval, and purchase medical data content from educational institutions. In some embodiments, the digital marketplace 200 may be used by government health care and regulatory entities to monitor real-time activity and conducting research to help formulate policy, assess impact thereof and detect or react to adverse conditions or evolving threats.

Practice data nodes 120 may generate packaged data by applying a template, much like a wizard, to take raw medical data and leverage it for e-learning, analytics, and other “objects” to buy, sell, and transact through the network 100. These objects are also referred to as “wares.” Wares may include a collection of related information or data that makes up an item for sale and/or any digital media file (raw data, audio, video, document, etc.) that a content seller has rights to sell (i.e., white papers, e-learning objects, best practices, etc.). For example, Wares may include micro-publishing products from physicians and researchers such as studies, reports, trials, techniques or just about any content others may be willing to purchase “a la carte.” This provides a substantial financial justification for installing the network. Each practice may establish a “template” for dynamic wares (royalties, price per record, and licensing information). Then when purchase happens, the system creates the dynamic ware and applies royalties, pricing, and licensing.

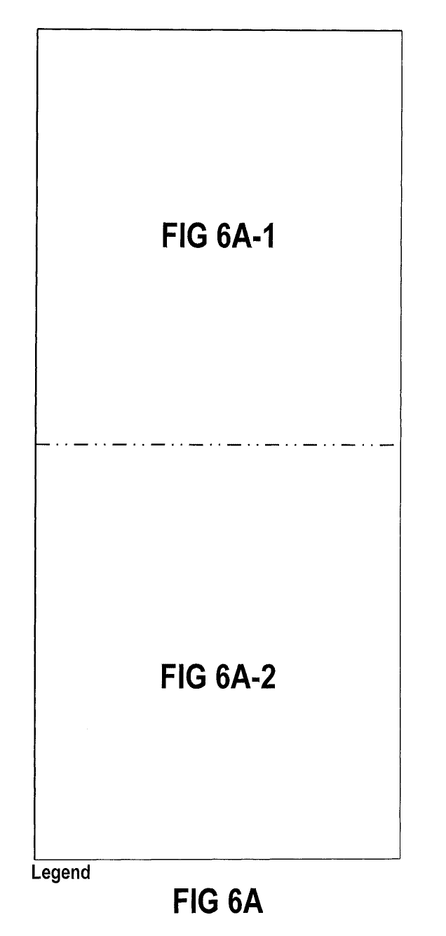

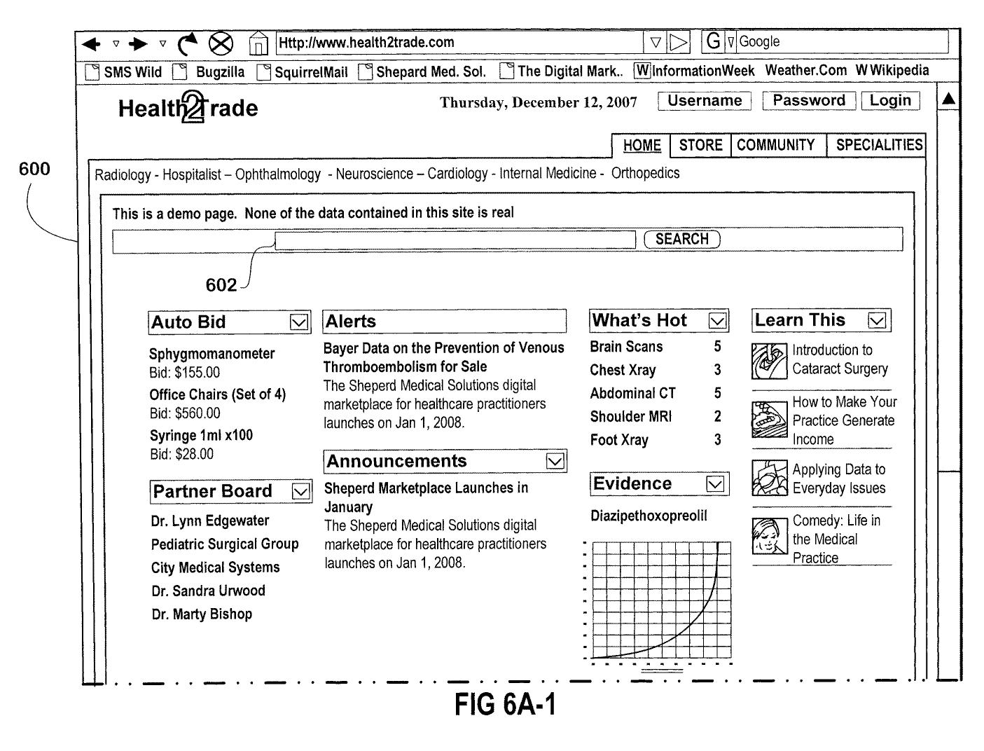

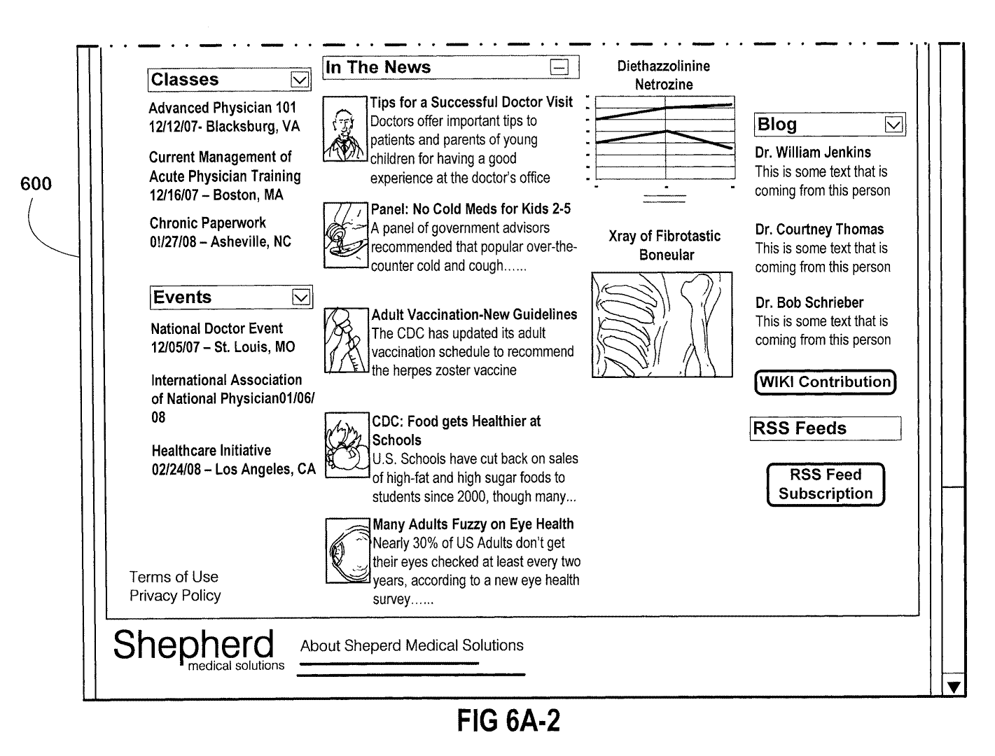

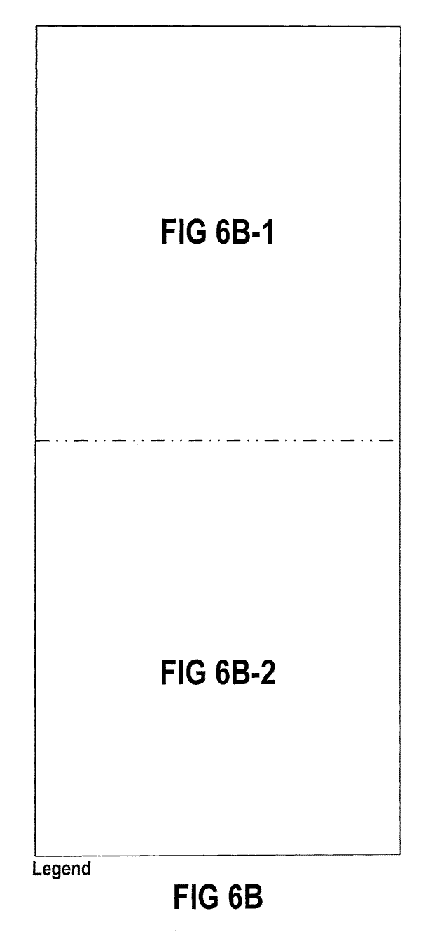

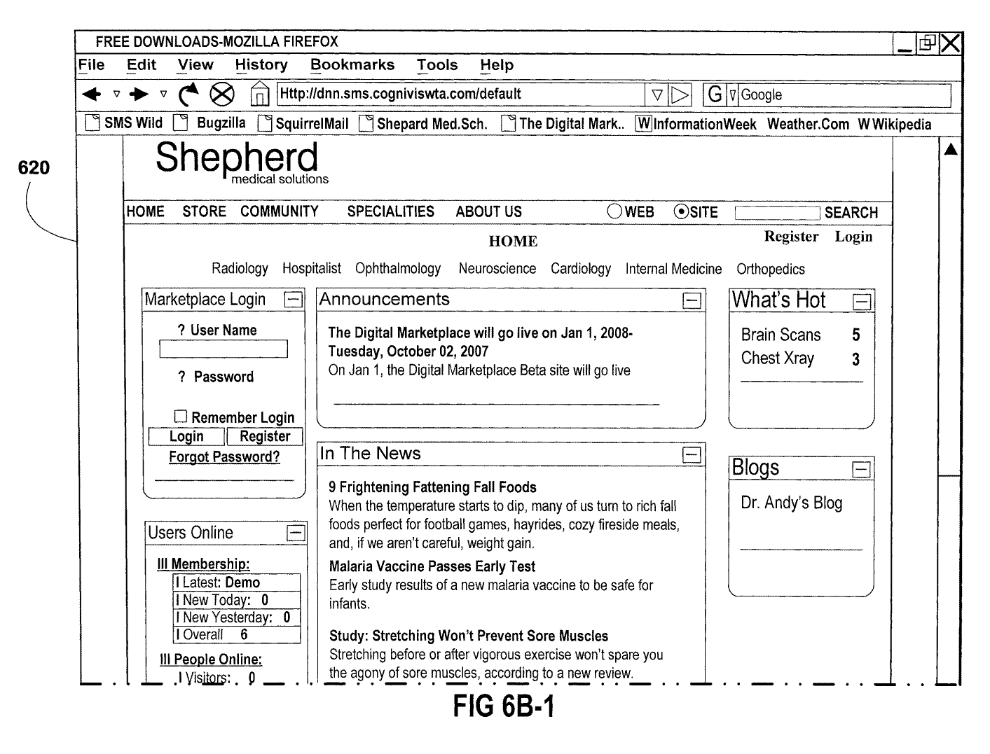

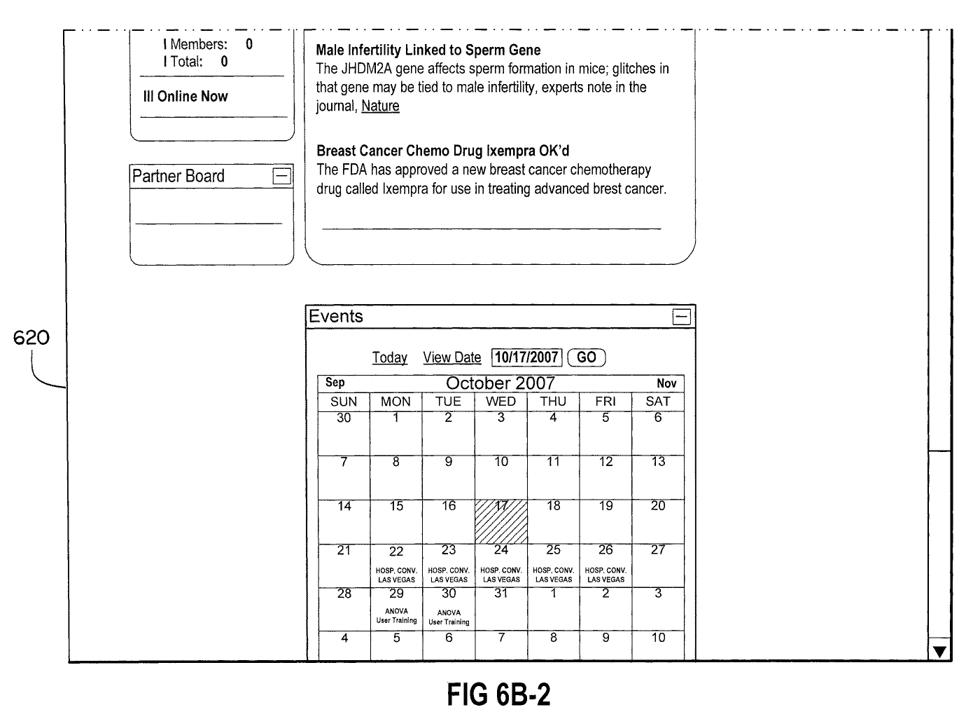

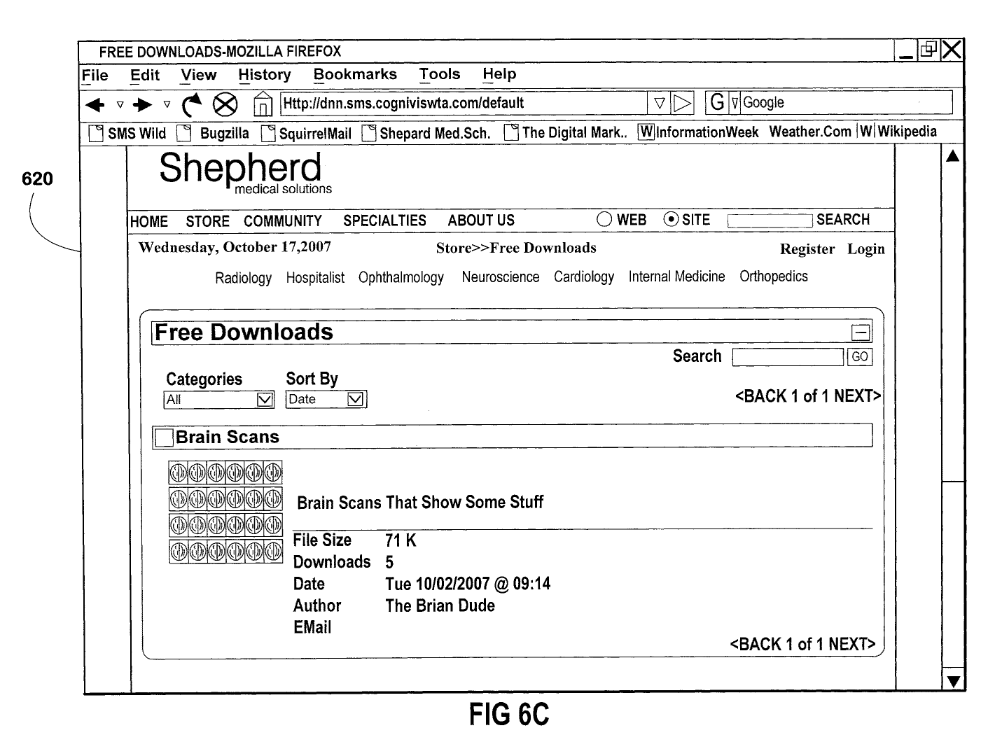

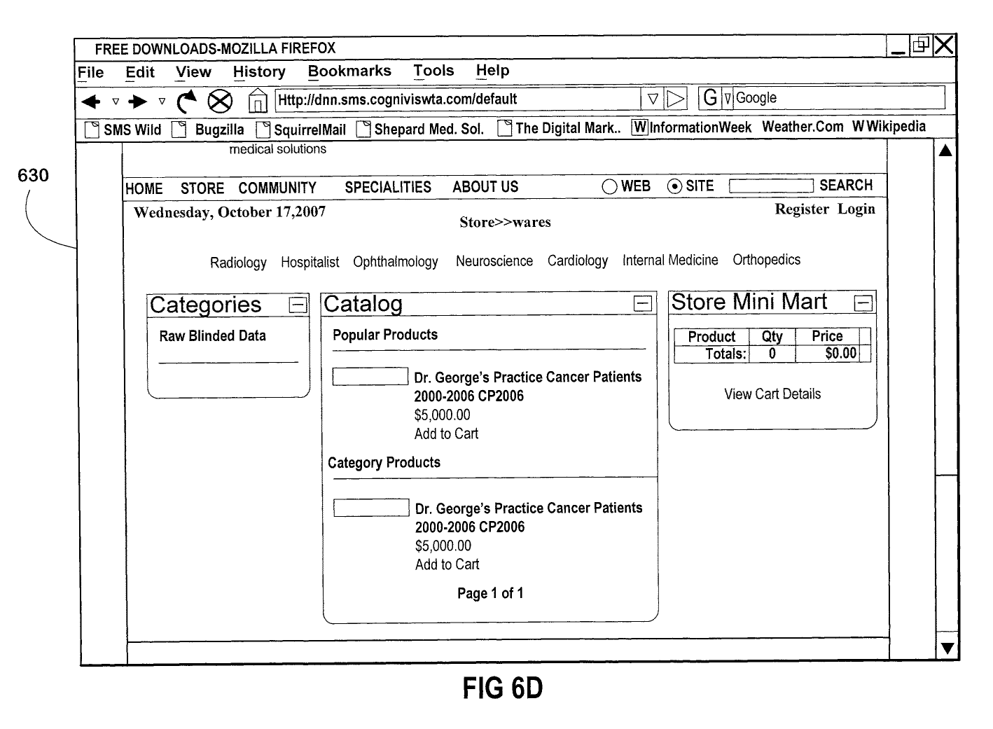

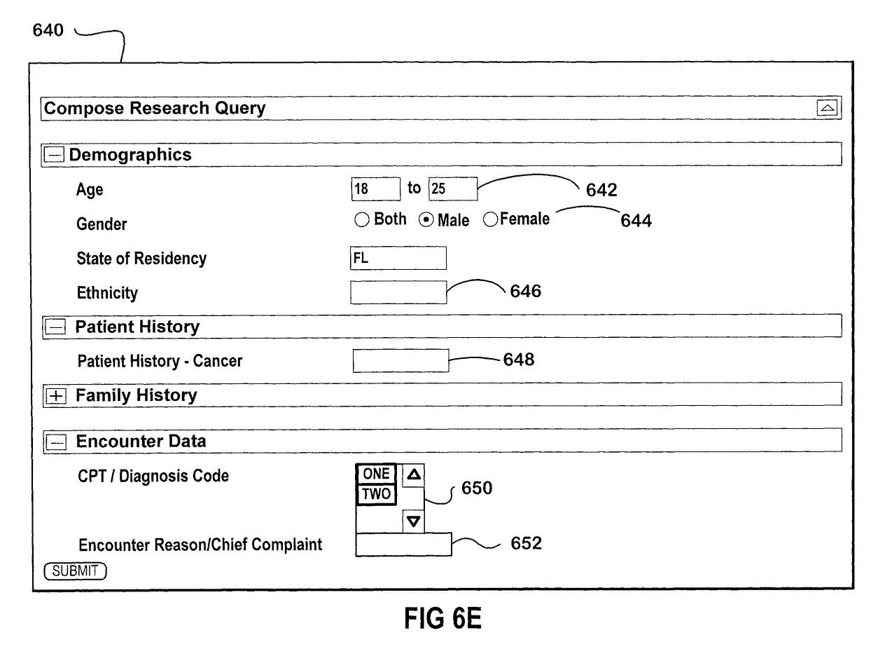

A ware may have one or more royalties associated with it. The digital marketplace system supports one or more royalty distribution schemes. The digital marketplace allows content buyers to browse and purchase available wares using a credit card or a point system. The digital marketplace system of the present invention may also offer “free downloads” at the discretion of the sellers or the Aggregators and/or consolidators Community of Users. See, e.g., FIG. 6C.

In a preferred embodiment, peers, such as practice data nodes 120, must be authenticated by a trusted peer authentication node and run a trusted and unaltered version of the peer network software (latest security patches) in order to communicate on the network 100. The system may include peer authentication nodes responsible authenticating the individual user peer nodes (e.g., practice data nodes 120). For example, the peer authentication nodes may confirm the identity of a practice. The peer authentication node may also be responsible for authenticating the individual users. A preferred embodiment includes at least one authentication peer node per state who assumes the responsibility of enforcing policies for peers within its state.

In some embodiments, certain users, such as sellers of medical data or content, need to be licensed medical professionals. In such embodiments, the system will authenticate the users by requiring written documentation as proof of a user's medical license. Since medical licenses expire or can be revoked, the digital marketplace 200 periodically requires updated documentation proving that the medical professional is still in good standing with any appropriate state licensing boards. To register, a new user fills out a user registration form on the digital marketplace website to register. The system asks the user if they want to be a buy and sell user, or a buy only user. The user fills out the form and provides the following minimal information: Name, Contact information (address, phone, fax, etc), Email address, Profession (select from list), License information (state, agency, license number, etc). The system asks the user if they would like to upload a scanned copy of their license information or to fax it later. If the user selects upload, then the system prompts for the file to upload. If the user selects fax, then the system provides them with a fax number and reference number. The user clicks Submit. The system stores the information in a database. The system emails a link to the user's email address. The user receives the email and clicks on the link in the email. The system thanks them for registering and informs them that their account is pending confirmation and authorization and that the user will receive another email informing them that the account is ready to use.

If the user is buy-only user then the system activates the account. The system emails the buy only user informing them that their account is now active. If the user is a buy and sell user, then a task is queued to a digital marketplace administrator. For buy and sell users, a digital marketplace administrator needs to verify the seller's professional license documentation. This documentation will either be uploaded as a scanned document or faxed. In either situation, a human must review the documentation and manually authorize the user account.

Users and/or participants in the system are assigned one or more identifiers. Practices 120 have a practice user-identifier (“UID”) which may be randomly assigned. Each consolidator 110 has a consolidator UID. Patients, whose medical records and/or patient data are stored by a practice 120 and managed and/or accessible by one or more consolidators 110, have a unique patient user-identifier (“UID”). In a preferred embodiment, the patient UID is a combination of their practice UID and a P2P UID. The P2P identifier is assigned by their consolidator 110. The patient UID may be housed at the practice 120 and the consolidator 110. All data pertaining to the patient is linked to this identifier. Other practices 120 and the research network 100 cannot relate a patient identifier back to a person.

The digital marketplace 200 includes a plurality of ecommerce features including but not limited to shopping carts, browsing, searching, user profiling, and credit card authentication. Digital products offered via the digital market place include raw data, processed data, unstructured content, reports, etc. The unstructured content may include, for example, e-learning, journal articles, study write-ups, images, video, and/or audio. Templates are provided for packaging and organizing data into digital products (e.g., wares). The digital marketplace 200 further includes media libraries accessible via the user interface. Pictures, video, music, sound clips, etc can be either sold as digital products or used as a digital work in a custom built digital product.

Services may also be offered via the digital marketplace 200. The services may include transcription services, file storage services, accounting, payroll, consulting, billing clearinghouse, and the resale of other vendors digital products such as classes, content, books, etc. Other products offered via the digital marketplace 200 may include equipment or supplies from vendors, wanted ads, automatic postings to financial management system, reporting, interest profiling, etc.

The digital marketplace 200 further includes a content management system 230 (“CMS”) including any number of computer files, image media, audio files, electronic documents and web content. The digital marketplace 200 also includes web application framework 240 including various software applications 242 such as user account management software, security software, and logging software.

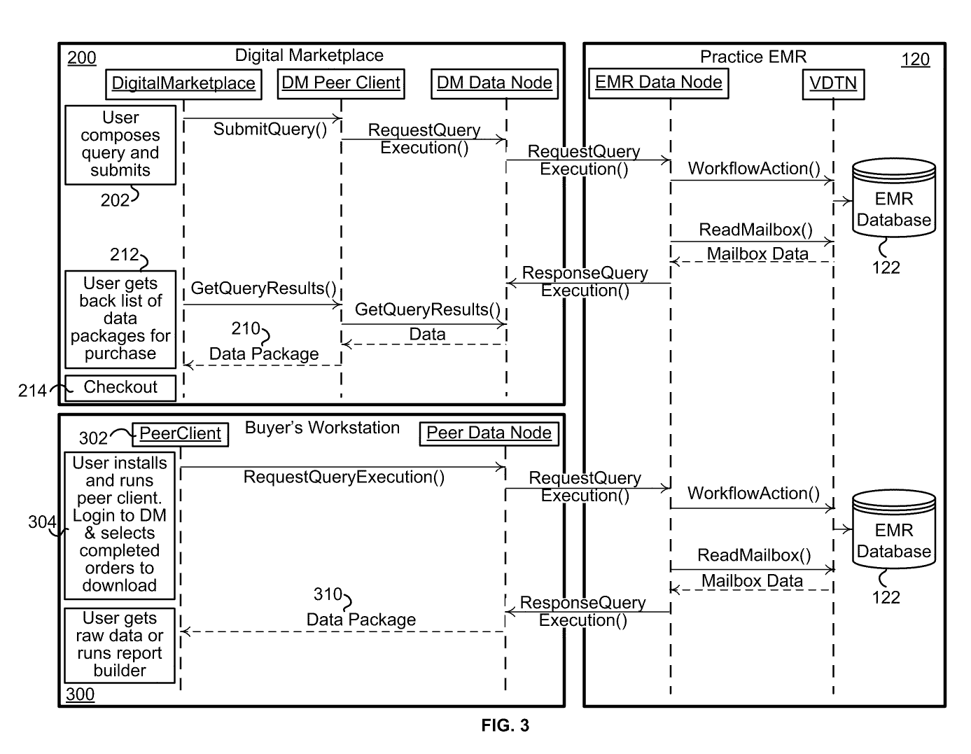

FIG. 3 illustrates a sequence diagram of how data flows between the digital marketplace 200, a practice 120 (e.g., seller), and a user or buyer 300. The system may include any number of buyer workstations 300 having access to the digital marketplace 200 via the Internet. A user composes a query 202 and submits the query to the digital marketplace 200. In a preferred embodiment, the query is submitted via an internet accessible user interface, such as user interface 600 including a search box 602 (FIG. 6A) and/or user interface 640 including search boxes 642-652 (FIG. 6E). In other embodiments, the query may be submitted via a software application executing on the user/buyer's workstation 300, such as the peer client 302.

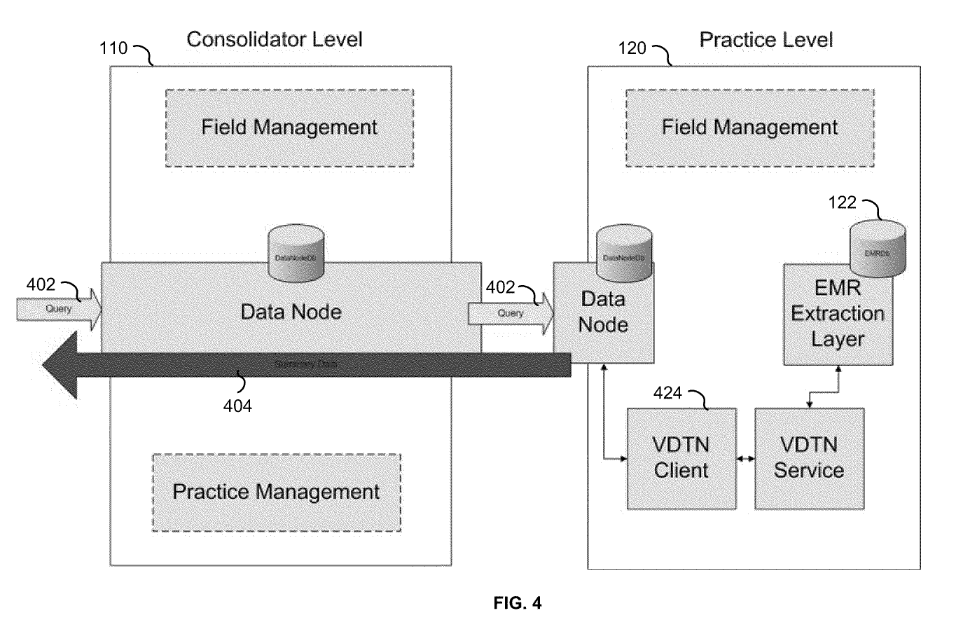

The query is submitted to the P2P network 100 for execution, and P2P nodes (e.g., consolidators 110, practices 120, etc.) respond with meta data and/or summaries 210 of data available in their databases 122 responsive to the query. As further illustrated in FIG. 4, the query 400 may be received by a consolidator 110 associated with a plurality of practices 120 and transmitted to the practices 120. The practices 120 then extracts a summary of the responsive data from its electronic medical records, and uses its VDTN client 424 software to remove patient identification data from, or “blind,” the summary data 404. Thus, the summaries do not include any information that can identify the patient to which the data pertains. The summary data 404 is then transmitted back to digital marketplace 200 for display to the potential buyer.

The digital marketplace 200 displays the user a list of each practice package available for purchase 212 via the user interface. The digital marketplace 200 does not have data itself, only meta data and a reference to the query. The user sees a breakdown of records available by practice (non-identifying of practices), and may choose one or more practice packages to add to shopping cart. The user checks out 214 through shopping cart and provide payment information (e.g., credit card).

Payment and credit card may be authenticated through a transaction handler 60 and/or clearing house 70 as shown in FIG. 1. If the credit card is authenticated, then the buy is presented with a confirmation page that contains a confirmation number and a receipt to print out.

The user is also provided with a verification code and a download link for the P2P node/practice having the purchased data. The user logs into P2P client software 302 and enters verification code to download (see, e.g., 304) the data package 310 from the appropriate nodes. The digital marketplace 200 knows what practices provided the data and need to get paid, but this information is not visible to buyer. A transaction processor and/or a transaction engine (e.g., software) of the digital marketplace 200 processes payments, splits royalties, distributes money to seller, and interacts with one or more banks and/or credit card clearing houses 70.

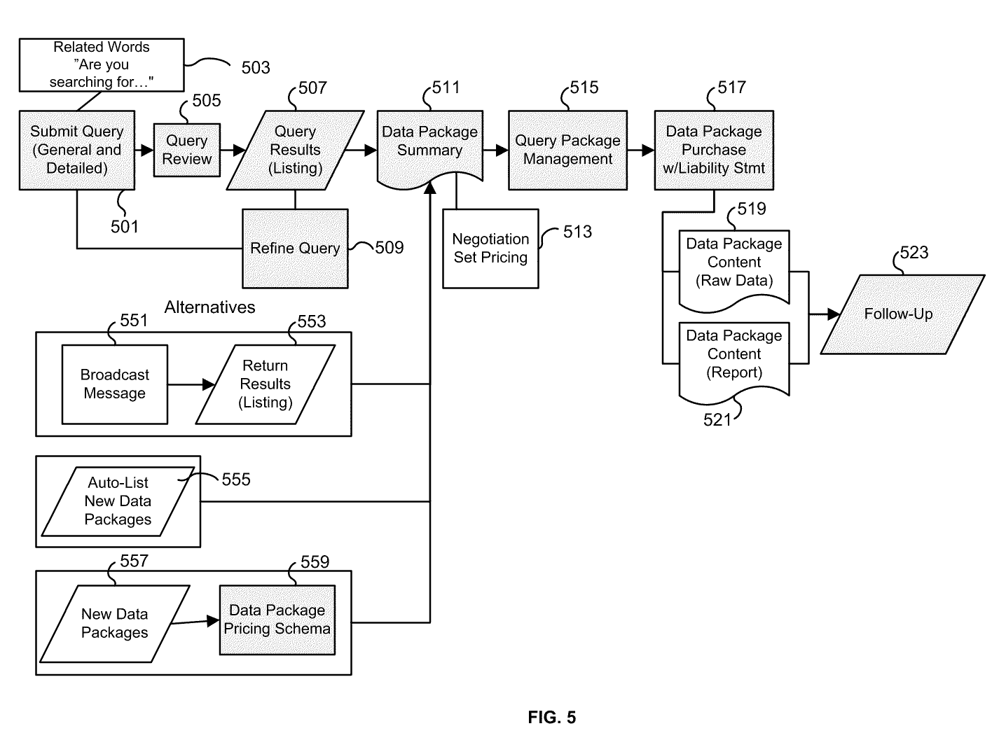

FIG. 5 illustrates how a query is built, results are returned, data packages are negotiated and communication channels using broadcast and negotiation features. The user submits a query 501 (e.g., via a user interface 600 and/or 640). A query is defined by one or more query terms. In one exemplary embodiment, each query term is composed of a search field (e.g., the field to search), a comparison operator (e.g., equals, greater than, contains), and a value or range, e.g., Age <25, wound size between 1 and 3, etc. In some cases, the user receives feedback 503 from the digital marketplace (e.g., related words) to assist with the query.

The query is broadcast to all data nodes in the network 100 and reviewed 505. In some embodiments, the user first receives a list 507 identifying quantities of available categories by criteria. Based on this information, the user may choose to refine 509 or revise the query. Summaries of data packages 511 available from each data node with responsive data are then be presented to the user. The summaries are blinded (e.g., by the practice nodes 120) and do not include any patient identifiable information. Some data packages may be listed on the digital marketplace 200 prior to the query, such as auto-listed data packages 755 and new data packages 759. Other data packages are listed or identified in response to the broadcast message 751.

The broadcast or flood message feature of the system provides for the blasting data requests, and also ads, and/or other content out to the users and communication within the medical community. As in this example, if a buyer is interested in a certain type of data or a study that is not posted, they “announce” it on the network 100. If a seller wants to aggregate the data and prepare it for sale, he would answer the announcement, prepare the data, post the data, and sell the data. The broadcast network feature encourages practitioners to upload additional data not yet in electronic form, and significantly broadens the amount of blinded data that could be obtained about various illnesses and treatments. The digital marketplace 200 also provides for point-to-point and private messaging between nodes and/or users. For example, a user can send a private message by entering the username they want to send a private message to. The system confirms the username and sends the message.

Prices for the data and data packages may be fixed in advance and/or negotiated 513 with the sellers. For example, sellers may have one or more predefined pricing schemes, such a particular price per record to be charged to buyers and a particular royalty to be paid to the digital marketplace 200. A particular data package summary may also include a negotiation button to option to allow the buyer to submit a bid that the seller may accept (go to Checkout), counterbid (renegotiate) or rejects (renegotiate or stop bidding). The buyer may also message the seller to discuss and negotiate a price. If a price is settled on and confirmed, the buyer goes to checkout. The buyer and potential seller(s) may negotiate a price for one digital product or many digital products. Seller(s) can gather data/content for a digital product and post the digital product in “private setting” or out to public across network. The buyer is notified and proceeds to checkout.

Based on the summaries provided to the user, the user selects data packages, or parts of one or more data packages, to purchase. The data packages are added to a shopping cart via a user interface of digital marketplace 200. After selection of desired data packages, the user purchases the data packages 517. The user then uses the P2P client to download the data package content 519/521 from the appropriate node having the data package. For example, the user may provide a receipt to each data node, which then validates the receipt. Once the receipt is validated, the data package stored on the data node is accessed to retrieve the list of patient identifiers. An EMR database of the data node is then accessed to retrieve medical records for the given patients. The data is blinded and encrypted then stored in the data package and is sent back to the user's peer-to-peer client. The user then decrypts the blinded data and saves the data to their computer.

FIGS. 6A-6E illustrate exemplary user interfaces of the digital marketplace system according to the present invention. The user interface is a robust graphical user interface wrapper that provides a positive user experience to interact with the machine and the data.

The user interface of the system allows users to search, purchase, promote and sell digital products and wares to other users of the system. Users can access account settings (e.g., My Account) to change passwords, change contact information, and change billing information (credit card/address). Users can view information and digital data that they have created, stored and/or offered via the system (e.g., My Digital Library; View My Projects; View My Digital Product Packages—list of digital products packaged and ready for sale; View My Posts—wiki posts, forums, blogs, peer reviews, product reviews; Manage a blog; View My Store—ecommerce stats products the user is selling; View and manage My Contacts). Users can access a list of the digital products for sale, change the price, delete, and make private or public. Users can also post and view wanted ads (e.g., My want ads) and private responses from other members (e.g., View and send Private Messages). Private messages of the system also enable users to communicate with each other in a private way (non-community communication), e.g., for want ads and negotiating price or terms of digital products.

Anonymous or registered users can browse and search the marketplace 200 via the online user interface. The marketplace 200 may be organized into categories or catalogs of digital products. Each digital product will have metadata associated with it. The user can browse the categories or catalogs. The user can search for digital products that match criteria on the metadata (or possibly even in the text of the content or abstract of the content).

A user can click on a category, catalog, or tag link. The system displays a list of digital products (or categories or subcategories) associated with the link clicked by the user. The user reviews the list and clicks on a product or category or tag. If the user clicked on a digital product the system displays the digital product's detail page. Users can also search criteria (e.g., metadata and/or text of the content) for any matching digital products. The system displays a list of digital products.

Buyers of digital products can post an interest in purchasing a digital product with a given criteria. This is data or content that a buyer would like to have. This is sent out to the community and sellers can respond and possibly negotiate a contract. The system presents a form to the buyer with a set of fields necessary for specifying the criteria for the digital product. System records request and notifies sellers whose notification criteria matches that of the want ad. Buyers may also have searches stored that are meant to notify the buyer when a new digital product matching their criteria has been posted. This will most likely be a scheduled task that runs periodically.

Sellers can post digital products for sale by clicking on Post Digital Product for Sale on the user interface. The system prompts for the packaged digital product. The seller selects the packaged digital product. The system prompts for any royalty related information that may be required. The system prompts for pricing and licensing information. The system prompts for public or private posting (e.g., anybody can see it and buy it or only invited users). The content creator clicks Submit (e.g., or Announce) and the system posts the digital product to the digital marketplace catalog. When the system has confirmed that data has been written to all systems, it changes a pending status to an active status. Buyers can now see it.

A user or a system content manager could manually compile raw data from system server databases into wares. A set of users may also collaborate in creating or modifying wares in a project workspace. For example, a user or multiple users may (1) collect blinded medical data, (2) analyze the medical data, (3) compose a journal article, (4) micro-publish the article, analysis and associated medical data, then (5) sell the published ware in the digital marketplace system. A set of users could then be selected to (6) peer-review the work and add their comments to the published work. Royalties are paid to each of the members who contributed in the project workspace (those who gave data, those who analyzed the data, those who did the write-up). If the article leads to some new technique or break-through, (7) an eLearning package could be created based on the work of the article.

Although the invention has been described with reference to a particular arrangement of parts, features and the like, these are not intended to exhaust all possible arrangements or features, and indeed many modifications and variations will be ascertainable to those of skill in the art.

What is claimed is:

1. A system for facilitating commercial exchange of packages of electronic health records, comprising:
two or more nodes in communication with one another via a peer to peer network, at least a portion of the nodes including a plurality of electronic medical records;
a digital marketplace server in communications with the peer to peer network including software for receiving a query from a user;
software executing on said server for identifying at least one of the nodes having medical data responsive to the query;
software executing on said server for displaying to the user summaries of the medical data responsive to the query;
software executing on said server for receiving an order for at least a portion of the medical data described in the summaries; and
software executing on said nodes for transmitting the ordered medical data from said nodes having the medical data to the user.

2. The system according to claim 1, wherein the electronic medical records pertain to one or more patients, wherein the electronic medical records include the medical data and patient identification data.

3. The system according to claim 2, wherein said nodes include software for removing the patient identification data from the summaries and the ordered medical data.

4. The system according to claim 1, wherein said software for receiving the order receives payment from the user, the payment based on price terms predefined by said nodes having the ordered medical data.

5. The system according to claim 1, wherein said software for receiving the order receives a price bid from the user and an acceptance or counterbid from said nodes having the ordered medical data.

6. The system according to claim 1, further comprising:
software executing on said nodes for generating the summaries of the medical data responsive to the query, blinding the summaries and transferring the summaries omitting patient identification data to said digital marketplace server.

7. The system according to claim 1, wherein said software for transmitting the medical data from said nodes blinds electronic medical records containing the ordered medical data and transfers the blinded medical data omitting patient identification data to the user.

8. The system according to claim 1, wherein said software for receiving the order transmits to the user a verification code and a link to the particular nodes having the ordered medical data.

9. The system according to claim 1, further comprising:
authentication software executing on at least one of said nodes for authenticating each of said nodes and users of said nodes.

10. The system according to claim 1, wherein the nodes include at least one data consolidator having access to the plurality of medical records.

11. The system according to claim 1, wherein the nodes include a plurality of medical practices, wherein the plurality of medical records are stored by the practices.

12. The system according to claim 1, wherein the medical data includes information regarding at least one medical condition and at least one treatment.

13. The system according to claim 1, wherein at least a portion of said nodes includes software for encrypting and decrypting the summaries and the medical data.

14. A system for facilitating commercial exchange of packages of electronic health records, comprising:
a plurality of practice nodes in communication with one another via a peer to peer network, each practice node having a plurality of electronic medical records including medical data and patient identification data;
a digital marketplace server in communication with one another via a peer to peer network including software for receiving a query for medical data from a user;
software executing on said server for identifying at least one of the practice nodes having the medical data responsive to the query;
software executing on said practice nodes for generating summaries of the medical data responsive to the query, blinding the summaries and transferring the blinded summaries omitting patient identification data to said digital marketplace server;
software executing on said server for displaying the blinded summaries to the user;
software executing on said server for receiving an order for at least a portion of the medical data described in the blinded summaries; and
software executing on said practice nodes for blinding electronic medical records containing the ordered medical data and transferring the blinded medical data omitting patient identification data to the user.

15. The system according to claim 14, wherein said software for receiving the order receives payment from the user, the payment based on price terms predefined by said nodes having the ordered medical data.

16. The system according to claim 14, wherein said software for receiving the order receives a price bid from the user and an acceptance or counterbid from said nodes having the ordered medical data.

17. The system according to claim 14, wherein the user is one of said practice nodes.

18. The system according to claim 14, wherein the medical data includes information regarding at least one medical condition and at least one treatment.

19. A method for commercial exchange of packages of electronic health records, comprising the steps of:
receiving a query for medical data from a user;
identifying at least one of a plurality of nodes having the medical data by broadcasting the query via a peer to peer network to the plurality of nodes and receiving, from at least one of the nodes, summaries of the medical data available at the node;
transmitting the summaries of the medical data available from the nodes to the user;
receiving an order for at least a portion of the medical data described by the summaries from the user;
receiving payment from the user; and
transmitting the ordered medical data from the particular nodes having the ordered medical data to the user.

20. The method according to claim 19, wherein the nodes blind the summaries to omit patient identification data before the summaries are transmitted to the user.

21. The method according to claim 19, further comprising the step of:
blinding the ordered medical data to remove patient identification data.

22. The method according to claim 19, wherein said step of receiving payment includes receiving a price bid from the user and an acceptance or counterbid from said nodes having the ordered medical data.

23. The method according to claim 19, further comprising the step of:
transmitting at least a portion of the payment to the nodes having the ordered medical data.

24. The method according to claim 19, wherein the query is received via an internet-based user interface.

25. The method according to claim 19, wherein the nodes include the medical data and patient identification data, wherein the method further comprises the step of removing the patient identification data from the summaries, and removing the patient identification data from the medical data.
